(19) United States
(12) Patent Application Publication
(10) Pub. No.: US 2009/0005466 A1
(43) Pub. Date: Jan. 1, 2009

(54) Open-Celled Foam Which Repels Water Vapor and a Process for Producing It

(75) Inventors: Horst Baumgartl, Mainz (DE); Christof Mock, Mannheim (DE); Bernhard Vath, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/064,349

(22) PCT Filed: Aug. 22, 2006
(86) PCT No.: PCT/EP2006/065551

§ 371 Date: Sep. 15, 2008

(30) Foreign Application Priority Data
Aug. 22, 2005 (DE) 10 2005 039 626.7

(51) Int. Cl. C08J 9/00; C08F 214/22; C08F 214/08; C08L 61/28; C08L 61/24; C08L 75/04

(52) U.S. Cl. 521/136; 521/145; 521/137; 521/134

(57) ABSTRACT

The invention relates to a foam which has been made hydrophobic/oleophobic and comprises a foam matrix having open cells and having an impregnation which is made up essentially of a polyvinylidene halide (co)polymer which may optionally comprise further substituents and, if appropriate, additionally a fluorocarbon resin and/or silicone resin. The invention further relates to a process for producing this foam.

The invention relates to a foam which comprises a foam matrix having essentially open cells and has been made hydrophobic/oleophobic and whose foam matrix is additionally provided with a coating which is impermeable to water vapor. The invention further provides a process for producing such a foam.

Open-celled foams comprising various materials are employed, for example, in thermal or acoustic insulation of buildings and vehicles. Furthermore, open-celled foams are used for the acoustic and thermal insulation of plants and equipment in mechanical engineering.

To prevent the foam from becoming fully soaked with water or oil, DE-A 100 11 388 discloses making a melamine resin foam hydrophobic/oleophobic by coating the foam skeleton with a hydrophobic and oleophobic component, for example a fluoroalkyl ester and silicone resin.

A process by means of which a melamine resin foam can be impregnated is known, for example, from EP-A 0 451 535. For this purpose, a binder is firstly applied to the surface of the melamine resin foam and the foam together with the binder is subsequently passed through a gap between two contrarotating rollers, with the gap between the rollers being set so that it is smaller than the uninfluenced thickness of the melamine resin foam. An additive for producing an oleophobic and/or hydrophobic effect can have been added to the binder.

It is an object of the present invention to provide an open-celled foam which has hydrophobic/oleophobic properties and additionally displays reduced water vapor absorption.

This object is achieved by a foam which comprises a foam matrix having essentially open cells and having an impregnation which is made up essentially of a polyvinylidene halide (co)polymer which may optionally comprise further substituents and, if appropriate, additionally a fluorocarbon resin and/or silicone resin.

Suitable foams for the purposes of the present invention are, for example, ones in which the foam matrix is made up of a melamine-formaldehyde polycondensate. Further suitable foams are ones in which the foam matrix is a urea-formaldehyde polycondensate and ones in which the foam matrix is an open-celled polyurethane foam. The foam matrix is preferably made up of a melamine-formaldehyde polycondensate.

In a particularly preferred melamine-formaldehyde polycondensate, the ratio of melamine to formaldehyde for producing the foam matrix is from 1:1.2 to 1:4.

Such melamine-formaldehyde foams are known, for example, from EP-B 0 071 672. The foams are accordingly produced by foaming an aqueous solution of a melamine-formaldehyde condensation product, with the solution comprising an emulsifier, an acid hardener and a blowing agent, preferably a C₅-C₇-hydrocarbon. The melamine-formaldehyde condensate is subsequently cured at elevated temperature.

Impregnation of the foam comprising a foam matrix having the essentially open cells with a polyvinylidene halide (co)polymer which optionally comprises further substituents leads to a reduction in the water vapor absorption of the foam. This reduced water vapor absorption makes it possible to use the foam in environments having a high atmospheric humidity or in environments in which water vapor is comprised without a noticeable deterioration in the properties of the foam. In addition, the weight increase in the foam resulting from the absorption of water vapor is reduced.

Suitable halides of the polyvinylidene halide or the polyvinylidene halide copolymer are, for example, chloride or fluoride. Preference is given to chloride.

Further substituents by which the polyvinylidene halide, or the polyvinylidene halide copolymer may optionally be substituted are, for example, alkyl, aryl or functional groups, for example ester or nitrile. Preference is given to the polyvinylidene halide (co)polymer comprising no further substituents.

For the purposes of the present invention, the term polyvinylidene halide (co)polymer encompasses both noncopolymerized polyvinylidene halide and copolymerized polyvinylidene halide. Copolymerization can, for example, be carried out using vinyl halide or acrylonitrile. The polyvinylidene halide copolymer is preferably copolymerized with vinyl halide. The preferred vinyl halide is vinyl chloride.

To give the foam hydrophobic and/or oleophobic properties so as to avoid uptake of liquid water and/or oil in addition to the reduced water vapor absorption, the impregnation in a preferred embodiment further comprises commercial impregnants comprising fluorocarbon resins or silicone resins.

In the impregnants, the fluorocarbon resin and/or silicone resin are preferably present in the form of emulsified droplets in water or volatile organic solvents such as methanol, ethanol, acetone, pentane. Water is preferred because it is nonflammable.

The impregnation leads to an increase in the density of the foam. This density increase results from the material with which the foam is impregnated enveloping the struts of the foam and thus increasing the cross section of the struts. The pore volume is slightly decreased as a result. In general, the impregnation with the polyvinylidene halide (co)polymer leads to a density increase of from 5 to 20%.

In addition to the impregnation with substances which repel water and water vapor, the foam is, in a preferred embodiment, impregnated with a flame retardant. Suitable flame retardants are, for example, halogen compounds (bromine and chlorine compounds), phosphorus compounds, nitrogen compounds, intumescent systems, mineral materials (based on aluminum and magnesium) and also borax, Sb₂O₃ and nanocomposites. To improve the flame-retardant properties of plastics, use is made of, for example, aluminum trihydroxide, brominated compounds, chlorinated phosphorus compounds, nonhalogenated phosphorus compounds, chloroparaffins, magnesium dihydroxide, melamines and borates. Suitable flame retardants known to those skilled in the art are described, for example, in the brochure “Flammschutzmittel, häufig gestellte Fragen” of the European Flame Retardants Association, January 2004.

The foam of the invention is preferably produced by a process comprising the following steps:
(a) application of a dispersion comprising vinylidene halide (co)polymer to the foam or soaking of the foam with the dispersion,
(b) pressing of the foam together with the dispersion in order to introduce the dispersion into the pores of the foam and
(c) drying of the foam together with the dispersion at a temperature in the range from 40 to 100° C.,
   with the steps (a) and (b) being carried out successively, firstly step (a) then step (b).

The application of the dispersion to the foam and the pressing of the foam can be carried out, for example, as described in EP-A 0 451 535. For this purpose, the foam is passed between two rollers rotating in the same direction, with the gap between the rollers being selected so that the foam is compressed in each case. The dispersion with which the foam is impregnated is fed onto the rollers which are horizontally next to one another, so that a pool of liquid is formed at the point at which the foam passes between the rollers. As a result of the rotational motion of the rollers and the pressing of the foam, the dispersion comprised in the pool of liquid is pressed into the foam. The dispersion envelops the struts of the foam and thus forms a closed surface alter curing.

After application of the dispersion and pressing of the foam, the foam which has been impregnated in this way is preferably dried in a drying oven at a temperature in the range from 40 to 100° C. During this treatment, the dispersion forms a film and thus a layer which acts as a barrier to water vapor on the cell struts.

If the struts of the foam are not yet completely enveloped with the impregnation after a single pass through the process or the layer thickness of the impregnation is still too low, the foam which has been impregnated in this first stage can also pass through the same impregnation process a plurality of times. In this way, the thickness of the layer enveloping the struts is increased in each step.

Apart from application of the substance with which the foam is to be impregnated and subsequent pressing, it is likewise possible to soak the foam with the substance with which it is to be impregnated and subsequently press it. For soaking, the foam is, for example, drawn through a bath comprising the at least one substance with which the foam is to be impregnated. However, any further method which is known to those skilled in the art and by means of which the foam can be soaked is also conceivable.

The polyvinylidene halide used for impregnation is preferably present as a dispersion in a solvent. Suitable solvents are, for example, short-chain alcohols, for example methanol or ethanol, or water. Water is particularly preferred as solvent.

The dispersion with which the foam is impregnated generally comprises from 5 to 60% by weight of polyvinylidene halide (co)polymer. The dispersion preferably comprises from 10 to 30% by weight of polyvinylidene halide (co)polymer.

To make the foam water-repellent in addition to the reduction in absorption of water vapor, the dispersion can additionally comprise fluorocarbon resin and/or silicone resin. In a first process variant, both the polyvinylidene halide (co)polymer and the fluorocarbon resin and/or silicone resin are applied as a mixture in one step to the foam or the foam is soaked with the mixture.

In a further process variant, it is also possible firstly to impregnate the foam with the dispersion comprising polyvinylidene halide (co)polymer and subsequently to soak the foam with a dispersion comprising fluorocarbon or silicone resin in a second impregnation step. In this way, a particularly hydrophobic/oleophobic foam having cell struts which repel water vapor is formed. The foam is subsequently dried. An initial drying can also be carried out immediately after impregnation with the dispersion comprising polyvinylidene halide (co)polymer. A second drying step is then necessary after the impregnation with the dispersion comprising fluorocarbon or silicone resin in this process variant.

In all process variants, pressing is preferably carried out as described in EP-A 0 451 535 by passing the foam through a defined gap between two contrarotating, parallel rollers.

Apart from passing the foam through a gap between two contrarotating rollers, it is also possible to apply the pressure necessary for impregnation by transporting the foam which has been impregnated with the dispersions on a conveyor belt and pressing a roller which rotates at a circumferential velocity which is equal to the velocity at which the foam is being moved onto the foam. Furthermore, the pressure can be applied to the foam by, for example, placing the foam in a press which presses a punch onto the foam. However, continuous pressing is not possible in this case.

Pressing can also be carried out by means of any further apparatus known to those skilled in the art.

The resins with which the foam is impregnated are in both embodiments preferably present as a dispersion in a volatile solvent. Suitable solvents are, for example, water or volatile alcohols such as methanol or ethanol. The resin is particularly preferably present in aqueous dispersion.

If the foam of the invention is used in an environment which is at 30° C. and has a relative atmospheric humidity of 90%, a reduction in the water vapor absorption of from 20 to 90% results.

A preferred field of use for the foam of the invention is air transport. As a result of the reduction in water vapor absorption, the increase in mass of the foam caused by absorption of water vapor is reduced. Since a weight increase leads to increased kerosene consumption in air transport, such an increase in mass caused by water vapor absorption is to be avoided if possible. This can be achieved by use of the foam of the invention.

### EXAMPLE

### 1. COMPARATIVE EXAMPLE

An unimpregnated melamine-formaldehyde foam is firstly dried at 100° C. for 24 hours and subsequently exposed to a relative humidity of 90% at 30° C. for 20 hours. The foam absorbs from 18 to 20% by weight of water vapor.

### 2. COMPARATIVE EXAMPLE

A melamine resin foam impregnated with a fluorocarbon resin emulsion to make it hydrophobic/oleophobic is firstly dried at 100° C. for 24 hours and subsequently exposed to a relative humidity of 90% at 30° C. for 20 hours. The foam absorbs from 17 to 19% by weight of water vapor.

### EXAMPLE

An open-celled melamine-formaldehyde foam is impregnated with an aqueous dispersion comprising 20% by weight of polyvinylidene chloride and subsequently dried at 100° C. for 24 hours. The dried foam is exposed to a relative humidity of 90% at 30° C. for 20 hours. The foam absorbs from 5 to 6% by weight of water vapor.

1. A foam which comprises a foam matrix having essentially open cells and having an impregnation which is made up essentially of a polyvinylidene halide (co)polymer which may optionally comprise further substituents and additionally a fluorocarbon resin and/or silicone resin.

2. The foam according to claim 1, wherein the halide is a chloride or fluoride.

3. The foam according to claim 1, wherein the foam matrix is made up of a melamine-formaldehyde polycondensate.

4. The foam according to claim 3, wherein the ratio of melamine to formaldehyde for producing the foam matrix is from 1:1.2 to 1:4.

5. The foam according to claim 1, wherein the foam matrix is a urea-formaldehyde polycondensate.

6. The foam according to claim 1, wherein the foam matrix is an open-celled polyurethane foam.

7. The foam according to claim 1, wherein the impregnation consists essentially of a mixture of the polyvinylidene halide (co)polymer and the fluorocarbon resin, the silicon resin or both, fluorocarbon resin and silicone resin.

8. The foam according to claim 1, wherein the impregnation is made up of two separate layers which respectively comprise essentially fluorocarbon resin, silicone resin or both, fluorocarbon resin and silicone resin or the polyvinylidene halide (co)polymer.

9. The foam according to claim 1, wherein the polyvinylidene halide copolymer is copolymerized with vinyl halide.

10. A process for producing a foam according to claim 1, comprising
(a) application of a dispersion comprising vinylidene halide (co)polymer and additionally a fluorocarbon resin and/or silicone resin to the foam or soaking of the foam with the dispersion,
(b) pressing of the foam together with the dispersion in order to introduce the dispersion into the pores of the foam and
(c) drying of the foam together with the dispersion at a temperature in the range from 40 to 100° C.,
with the steps (a) and (b) being carried out successively, firstly step (a) then step (b).

11. A process for producing a foam according to claim 1 comprising
(a) application of a dispersion comprising vinylidene halide (co)polymer to the foam or soaking of the foam with the dispersion,
(b) pressing of the foam together with the dispersion in order to introduce the dispersion into the pores of the foam and
(c) drying of the foam together with the dispersion at a temperature in the range from 40 to 100° C.,
(d) application of fluorocarbon resin and/or silicone resin to the foam or soaking of the foam with fluorocarbon resin and/or silicone resin after the drying in step (c),
with the steps (a) and (b) being carried out successively, firstly step (a) then step (b).

12. The process according to claim 11, wherein the foam together with the fluorocarbon resin, the silicone resin or both, fluorocarbon resin and silicone resin is pressed in order to introduce the resin into the pores of the foam, with the application or soaking of the foam with the resin and the pressing being carried out successively, and is, optionally subsequently dried at a temperature in the range from 40 to 100° C.

13. The process according to claim 10, wherein the water is used as solvent for the dispersion.

14. The process according to claim 10, wherein the dispersion comprises from 5 to 60% by weight of polyvinylidene halide (co)polymer.

15. The process according to claim 11, wherein the water is used as solvent for the dispersion.

16. The process according to claim 11, wherein the dispersion comprises from 5 to 60% by weight of polyvinylidene halide (co)polymer.

17. The foam according to claim 2, wherein the foam matrix is made up of a melamine-formaldehyde polycondensate.

18. The foam according to claim 2, wherein the foam matrix is a urea-formaldehyde polycondensate.

19. The foam according to claim 2, wherein the foam matrix is an open-celled polyurethane foam.

20. The foam according to claim 2, wherein the impregnation consists essentially of a mixture of the polyvinylidene halide (co)polymer and the fluorocarbon resin, the silicone resin or both, fluorocarbon resin and silicone resin.
